(19) United States
(12) Patent Application Publication
(10) Pub. No.: US 2020/0286360 A1
(43) Pub. Date: Sep. 10, 2020

(54) SEAT OCCUPATION ALERT SYSTEM AND METHOD, COMPUTER DEVICE AND READABLE STORAGE MEDIUM

(71) Applicant: ZICT Technology Co., Ltd, Shenzhen (CN)

(72) Inventor: Yueyi Chen, Shenzhen (CN)

(73) Assignee: ZICT Technology Co., Ltd, Shenzhen (CN)

(21) Appl. No.: 16/764,083

(22) PCT Filed: Jul. 25, 2018
(86) PCT No.: PCT/CN2018/097044

§ 371 Date: May 14, 2020

(30) Foreign Application Priority Data
Nov. 15, 2017 (CN) 201711130320.9

(51) Int. Cl. G08B 21/18; G01V 8/10; G01V 11/00

(52) U.S. Cl. CPC G08B 21/18; G01V 11/00; G01V 8/10

(57) ABSTRACT

Provided are an occupation alert system and method, a computer device and a readable storage medium. The occupation alert system includes: a first sensing component, disposed in a walking area of a place and configured for detecting trajectory information of a detected object; a second sensing component, disposed in a seat area of the place and configured for detecting pressure information corresponding to each seat disposed in the seat area; and a control module, electrically connected to the first sensing component and the second sensing component separately and configured to determine whether the each seat is occupied according to the trajectory information and the pressure information.

The present application claims priority to a Chinese patent application No. 201711130320.9 filed on Nov. 15, 2017, disclosure of which is incorporated herein by reference in its entirety.

### TECHNICAL FIELD

The present disclosure relates to the field of alert technologies and, in particular, to an occupation alert system and method, a computer device and a readable storage medium.

### BACKGROUND

With the improvement of social reading awareness, seats in study rooms and reading rooms is in short supply. Various uncivilized seat-occupation phenomena occur from time to time. To improve usage efficiency of public resources and prevent long-term occupation for social public resources, a seat occupation alert system has appeared. However, related seat occupation alert system tends to have seat occupation alert error, and has a high misjudgment rate of seat occupation alert.

### SUMMARY

The present disclosure provides an occupation alert system, including: a first sensing component, disposed in a walking area of a place and configured for detecting trajectory information of a detected object; a second sensing component, disposed in a seat area of the place and configured for detecting pressure information corresponding to each seat disposed in the seat area; and a control module, electrically connected to the first sensing component and the second sensing component separately and configured to determine whether the each seat disposed in the seat area is occupied according to the trajectory information and the pressure information.

The present disclosure further provides an occupation alert method, including: acquiring real-time trajectory information of a detected object; in response to determining that a trajectory corresponding to trajectory information acquired at a first moment overlaps with a seat area in a place, according to pressure information at a position of a seat corresponding to an overlapping area of the seat area and the trajectory corresponding to the trajectory information acquired at the first moment and a trajectory corresponding to trajectory information acquired at a second moment, determining whether the seat is occupied.

The present disclosure provides a computer device, including a processor which, when used for executing computer programs stored in a memory, executes any occupation alert method provided by the present disclosure.

The present disclosure further provides a computer-readable storage medium configured to store computer programs for executing any occupation alert method provided by the present disclosure when executed by a processor.

An occupation alert system and method, a computer device and a readable storage medium provided by the present disclosure may reduce the misjudgment of the seat occupation alert, improve intelligent level and accuracy of the seat occupation alert and deal with the occupied seats timely, thereby improving the usage efficiency of the seats in the public place.

### BRIEF DESCRIPTION OF DRAWINGS

FIG. 1 is a block diagram of an occupation alert system provided by an embodiment.

FIG. 2 is a flowchart of an occupation alert method provided by an embodiment.

FIG. 3 is a schematic diagram of an occupation alert method provided by another embodiment.

### DETAILED DESCRIPTION

The occupation alarm system provided by an embodiment compares signals acquired by a sensor and a preset threshold through installing a pressure sensor or an infrared sensor on a seat (including a table and a chair), and determines whether the seat is occupied, and if the seat is occupied, an alarm signal is sent, but defects of the occupation system provided in the embodiment are described below.

(1) Seats need to be re-purchased or existing seats need to be modified one by one, which requires a large investment and wastes energy.

(2) Seats belong to fragile products and maintenance cost of the occupation alarm system is high.

(3) Each seat needs to be connected and powered on, which is inconvenient to be installed and has a certain potential safety hazards.

(4) The pressure sensor or infrared sensor detects a single static sensing value of the corresponding seat, the accuracy is poor and misjudgment is easily to be caused.

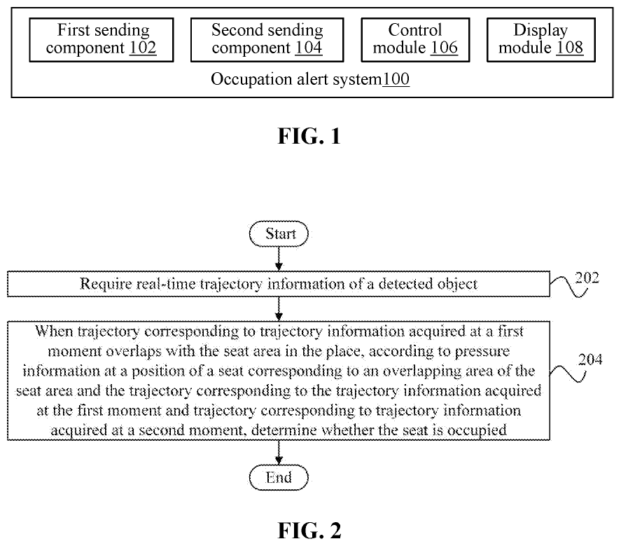

FIG. 1 is a block diagram of an occupation alert system provided by this embodiment. As shown in FIG. 1, the occupation alert system 100 provided in this embodiment is installed in a place, such as a public place. The public place includes a seat, a seat area disposed with a seat, and a walking area in addition to the seat area. The occupation alarm system 100 includes: a first sensing component 102, disposed in a walking area of a place and configured for detecting trajectory information of a detected object; a second sensing component 104, disposed in a seat area of the place and configured for detecting pressure information corresponding to each seat disposed in the seat area; and a control module 106, electrically connected to the first sensing component 102 and the second sensing component 104 separately and configured to determine whether the each seat disposed in the seat area is occupied according to the trajectory information and the pressure information.

In this embodiment, through detecting the trajectory information of the detected object by the first sensing component 102 provided in the walking area, and through detecting the pressure information corresponding to each seat by the second sensing component 104 provided in the seating area, acquisition of the trajectory information and pressure information is implemented, which facilitates identification of whether the each seat is occupied. Through the control module 106 which is electrically connected to the first sensing component 102 and the second sensing component 104, whether the each seat is occupied is determined according to the trajectory information and the pressure information, which improves the intelligence level of the occupation alert, reduces misjudgment rate of the occupation alert, improves accuracy of the occupation alert, and timely deals with the occupied seat, thereby improving usage efficiency of seats in the public place.

The walking area and the seating area may be carpeted with the first sensing component 102 and the second sensing component 104, which is difficult to be worn, is easy to be installed, reduces the maintenance cost, and improves safety by disposing the connected lines under the floor.

In an embodiment, the first sensing component 102 includes at least one pressure sensor disposed in the walking area, and the at least one pressure sensor is distributed in an array in the walking area.

In this embodiment, through distributing the pressure sensor in an array in the walking area, the acquisition of the pressure information in the walking area is implemented. When the detected object passes, the pressure information will change suddenly. The trajectory information may be acquired through the pressure information, which improves accuracy of the trajectory information acquisition, thereby improving accuracy of seat occupation alert.

In addition, coordinates of a position of the pressure sensor may be virtually corresponded, for example, a coordinate system is established according to an area where the pressure sensor is located, and corresponding coordinates are set for each pressure sensor. Information corresponding to coordinates of the pressure sensor and the pressure information is used as the trajectory information, which further improves the recognition of the trajectory information.

The pressure sensor may be a piezoresistive pressure sensor or a piezoelectric pressure sensor.

In an embodiment, the first sensing component 102 includes at least one infrared sensor disposed in the walking area, and the at least one infrared sensor is distributed in an array in the walking area.

In this embodiment, through distributing the infrared sensor in an array in the walking area, acquisition of an infrared value in the walking area is implemented. When the detected object passes, the infrared value will change suddenly, i.e., the trajectory information may be acquired through the infrared value, which improves accuracy of the trajectory information acquisition, thereby improving accuracy of seat occupation alert.

In addition, coordinates of a position of the infrared sensor may be virtually corresponded, for example, a coordinate system is established according to an area where the infrared sensor is located, and corresponding coordinates are set for each infrared sensor. Information corresponding to coordinates and the infrared value is used as the trajectory information, which further improves the recognition of the trajectory information.

In one embodiment, the second sensing component 104 includes a pressure sensor disposed on a floor of the seat area.

In this embodiment, through disposing the pressure information on the floor of the seat area, acquisition of the pressure information of each seat is implemented. The pressure information may improve the accuracy of judging whether the seat is occupied, thereby improving accuracy of the seat occupation alarm.

The pressure sensor may be a piezoresistive pressure sensor or a piezoelectric pressure sensor.

In one embodiment, the second sensing component 104 includes a pressure sensor disposed on the seat.

In this embodiment, through disposing the pressure sensor in the seat, acquisition of the pressure information of each seat is implemented. The pressure information may improve the accuracy of judging whether the seat is occupied, thereby improving accuracy of the seat occupation alarm.

The pressure sensor may be a piezoresistive pressure sensor or a piezoelectric pressure sensor. The seat in this embodiment includes, but is not limited to, a table and a chair. The pressure sensor may be disposed on a table leg or a chair leg, or a table face or chair face.

In one embodiment, the system further includes: a display module 108 disposed on the each seat, electrically connected to the control module 106, and configured to display prompt information indicating available, prompt information indicating being used or alarm information indicating occupied corresponding to the each seat.

In this embodiment, through the display module 108 provided on the seat, the prompt information indicating available, the prompt information indicating being used or the alarm information indicating occupied determined by the system may be intuitively displayed to the user and the management person, which is beneficial for the user to find the right seat timely, and helps the manager to deal with the occupied seats, improves the usage efficiency of seats in the public place.

The display module 108 may display different colors with display lights to indicate whether the seat is currently available, has been used, or is occupied.

In addition, a display screen is set in a relatively obtrusive public place where the screen corresponds to the seat. On the screen, different colors or symbols are used to show whether the corresponding seat is currently available, has been used, or is occupied, and usage status of all seats is updated in real-time.

FIG. 2 is a flowchart of an occupation alert method provided by one embodiment. As shown in FIG. 2, the occupation alert method provided by this embodiment includes the steps described below.

In step 202, real-time trajectory information of a detected object is acquired.

In step 204, when a trajectory corresponding to trajectory information acquired at a first moment overlaps with the seat area in the place, according to pressure information at a position of a seat corresponding to an overlapping area of the seat area and the trajectory corresponding to the trajectory information acquired at the first moment and a trajectory corresponding to trajectory information acquired at a second moment, whether the seat is occupied is determined.

In this embodiment, through acquiring the real-time trajectory information of the detected object, the judgment of whether the seat is occupied is triggered when a trajectory corresponding to real-time trajectory information overlaps with the seat area, which has a better realizability. Combined with the trajectory information acquired at the first moment and the pressure information at the seat position corresponding to the overlapping area of the seat area and the trajectory information acquired at the second moment, whether the seat is occupied is determined, which reduces the misjudgment of the seat occupation alert, improves intelligent level and accuracy of the seat occupation alert and deals with the occupied seats timely, thereby improving the usage efficiency of the seats in the public place.

In one embodiment, according to the pressure information at the seat position corresponding to the overlapping area of the seat area and the trajectory corresponding to the trajectory information acquired at the first moment and the trajectory corresponding to the trajectory information acquired at the second moment, determining whether the seat is occupied includes: acquiring the pressure information at the position of the seat; determining whether the pressure information is greater than the preset pressure threshold; if it is determined that the pressure information is not greater than the preset pressure threshold, the seat is determined to be not occupied and available for use; if it is determined that the pressure information is greater than the preset pressure threshold, then the duration is recorded, and whether the seat is occupied is determined according to the recorded duration and the trajectory information acquired at the second moment. The pressure information includes a pressure value.

In this embodiment, through acquiring the pressure information at the position of the seat, and determining whether the pressure information is greater than the preset pressure threshold, when it is determined that the pressure information is not greater than the preset pressure threshold, the seat is determined to be not occupied and available for use. When it is determined that the pressure information is greater than a preset pressure threshold, the duration is recorded, and whether the seat has been used or occupied is determined according to the recorded duration and the real-time trajectory information, the intelligence level of the occupation alert is further improved and a misjudgment rate of the occupation alert is reduced, accuracy of the occupation alert is improved, and the occupied seat can be timely dealt with, thereby improving usage efficiency of seats in the public place.

The preset pressure threshold may be the pressure information when the detected object is not at the seat position, or may be determined according to experiments, or may be calibrated to zero and periodically calibrated, which may further improve the accuracy of the occupation alert.

In an embodiment, determining whether the seat is occupied according to the recorded duration and real-time trajectory information includes: determining whether the duration is greater than a preset duration; if the duration is determined to be greater than the preset duration, whether the trajectory corresponding to the trajectory information acquired at the second moment is located at the overlapping area is determined, and the duration is zeroed. If the trajectory corresponding to the trajectory information obtained at the second time is located in the overlapping area, it is determined that the seat is not occupied and has been used; if it is determined that the trajectory corresponding to the trajectory information acquired at the second time is not in the overlapping area, then the seat is determined to be occupied.

In this embodiment, through determining whether the trajectory corresponding to the real-time trajectory information is located in the overlapping area when the duration exceeds a preset duration, the determination that the seat has been used and occupied is made. If the seat is already occupied, the detected real-time trajectory will move out of the overlapping area, which further improves the accuracy of the occupation alert and thereby improving the usage efficiency of the seats in the public place.

The preset duration may be set to 5 minutes. If the duration is too short, it is difficult to distinguish between occupied and has been used. If the duration is too long, the work efficiency is low, which does not facilitate the improvement of the usage efficiency of seats in the public place.

In one embodiment, the method further includes: displaying prompt information indicating available, prompt information indicating being used or alarm information indicating occupied corresponding to the seat.

In this embodiment, the prompt information indicating available, the prompt information indicating being used or the alarm information indicating occupied determined by the system may be intuitively displayed to the user and the management person, which is beneficial for the user to find the right seat timely, and helps the manager to deal with the occupied seats, improves the usage efficiency of seats in the public place.

The embodiment further provides a computer device, which includes a processor which, when used for executing computer programs stored in a memory, executes any occupation alert method provided by the embodiment when executed by a processor.

In this embodiment, the computer device includes a processor which, when used for executing computer programs stored in a memory, executes any occupation alert method provided by the present disclosure. Therefore, all beneficial effects of any occupation alert method provided by the embodiment are possessed.

The present embodiment further provides a computer-readable storage medium configured to store computer-executable instructions for executing the occupation alert method in this embodiment when executed by a processor.

In this embodiment, the computer-readable storage medium storing a computer program which, when executed by a processor, causes the processor to perform the any occupation alert method provided by the present disclosure. Therefore, all beneficial effects of any occupation alert method provided by the embodiment are possessed.

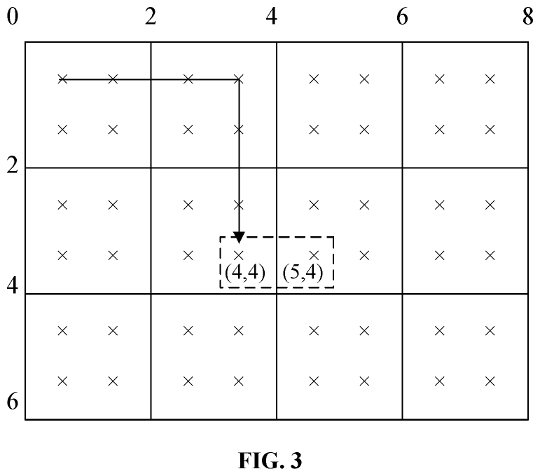

FIG. 3 is a schematic diagram of an occupation alert method provided by another embodiment. As shown in FIG. 3, according to the occupation alert method provided in this embodiment, 48 pressure sensors are arranged on the ground in an equidistant dot matrix manner, and each “x” in FIG. 3 represents a pressure sensor. Seats are preset on dotted rectangular areas (4, 4) and (5, 4). When the trajectory corresponding to the real-time trajectory information of the detected object moves from (1, 1) to (4, 4), it will trigger the judgement of whether the seat at (4, 4) is occupied. A pressure threshold may be 0. When it is satisfies that the pressure information of the seat is greater than a preset pressure threshold, and the trajectory corresponding to the real-time trajectory information does not leave the overlapping area, it is determined that the seat is not occupied and is being used, and the display module shows that the seat has been used.

The occupation alarm system and method, the computer device and readable storage medium provided by the above embodiments comprehensively detect the trajectory information of the detected object and the pressure information corresponding to the seat through the first sensing component provided in the walking area and the second sensing component provided in the seating area and can accurately identify whether the seat is occupied. The seat itself does not need to be modified, the intelligent level and accuracy of the occupation alert is improved, the occupied seats are dealt with timely, thereby improving the usage efficiency of the seats in the public place.

The steps in the above method embodiment may be adjusted, combined, and deleted as needed.

The units in the above device embodiment may be adjusted, combined, and deleted as needed.

All or part of the steps in each method provided by the above embodiments may be implemented by hardware related to program instructions, the program may be stored in a computer-readable storage medium, which includes a read-only memory (ROM), a random access memory (RAM), a programmable read-only memory (PROM), an electrically erasable programmable read-only memory (EEPROM), a one-time programmable read-only memory (OTPROM), an electrically-erasable programmable read-only memory (EEPROM), a compact disc read-only memory (CD-ROM) or another optical disc storage, a magnetic disk storage, a magnetic tape storage, or any other readable medium used to carry or store data of the computer.

Terms “above”, “below”, “left”, “right”, “front”, “rear” and the like indicating orientation or position relationships are based on the orientation or position relationships shown in the drawings, merely for facilitating and simplifying description, and these relationships do not indicate or imply that the referred apparatus or units must have a specific orientation and is constructed and operated in a specific orientation.

Description of “one embodiment”, “some embodiments”, “specific embodiments” and the like in the above embodiment means features, structures, materials, or characteristics described in the embodiment or example are included in at least one embodiment or example. Specific characteristics, structures, materials or features described in each embodiment may be combined properly in any one or more embodiments or examples.

What is claimed is:

1. An occupation alert system, comprising:
a first sensing component, disposed in a walking area of a place and configured for detecting trajectory information of a detected object;
a second sensing component, disposed in a seat area of the place and configured for detecting pressure information corresponding to each seat disposed in the seat area; and
a control module, electrically connected to the first sensing component and the second sensing component separately and configured to determine whether the each seat is occupied according to the trajectory information and the pressure information.

2. The system of claim 1, wherein
the first sensing component comprises at least one pressure sensor disposed in the walking area, and the at least one pressure sensor is distributed in an array in the walking area.

3. The system of claim 1, wherein
the first sensing component comprises at least one infrared sensor disposed in the walking area, and the at least one infrared sensor is distributed in an array in the walking area.

4. The system of claim 1, wherein
the second sensing component comprises a pressure sensor disposed on a floor of the seat area.

5. The system of claim 1, wherein
the second sensing component comprises a pressure sensor disposed on the each seat.

6. The system of claim 1, further comprising:
a display module, disposed on the each seat, electrically connected to the control module, and configured to display prompt information indicating available, prompt information indicating being used or alarm information indicating occupied corresponding to the each seat.

7. An occupation alert method, comprising:
acquiring real-time trajectory information of a detected object;
in response to determining that a trajectory corresponding to trajectory information acquired at a first moment overlaps with a seat area in a place, according to pressure information at a position of a seat corresponding to an overlapping area of the seat area and the trajectory corresponding to trajectory information acquired at the first moment and a trajectory corresponding to trajectory information acquired at a second moment, determining whether the seat is occupied.

8. The method of claim 7, wherein according to the pressure information at the seat position corresponding to the overlapping area of the seat area and the trajectory corresponding to the trajectory information acquired at the first moment and the trajectory corresponding to the trajectory information acquired at the second moment, determining whether the seat is occupied comprises:
acquiring pressure information at the position of the seat;
determining whether the pressure information is greater than a preset pressure threshold;
in response to determining that the pressure information is not greater than the preset pressure threshold, determining that the seat is not occupied and available for use; and
in response to determining that the pressure information is greater than the preset pressure threshold, recording a duration, and determining whether the seat is occupied according to the duration and the trajectory information acquired at the second moment.

9. The method of claim 8, wherein determining whether the seat is occupied according to the duration and the trajectory information acquired at the second moment comprises:
determining whether the duration is greater than a preset duration;
in response to determining that the duration is greater than the preset duration, determining whether the trajectory corresponding to the trajectory information acquired at the second moment is located in the overlapping area, and zeroing the duration;
in response to determining that the trajectory corresponding to the trajectory information acquired at the second moment is located in the overlapping area, determining that the seat is not occupied and has been used; and
in response to determining that the trajectory corresponding to the trajectory information acquired at the second moment is not located in the overlapping area, determining that the seat is occupied.

10. The method of claim 9, further comprising:
displaying prompt information indicating available, prompt information indicating being used or alarm information indicating occupied corresponding to the seat.

11. A computer device, comprising a processor which, when used for executing computer programs stored in a memory, executes an occupation alert method of claim 7.

12. A non-transitory computer-readable storage medium, which is configured to store computer programs for implementing the occupation alert method of claim 7 when the computer programs are executed by a processor.

13. The system of claim 2, wherein
the second sensing component comprises a pressure sensor disposed on a floor of the seat area.

14. The system of claim 3, wherein
the second sensing component comprises a pressure sensor disposed on a floor of the seat area.

15. The system of claim 2, wherein
the second sensing component comprises a pressure sensor disposed on the each seat.

16. The system of claim 3, wherein
the second sensing component comprises a pressure sensor disposed on the each seat.
